(19) United States
(12) Patent Application Publication
(10) Pub. No.: US 2011/0105081 A1
(43) Pub. Date: May 5, 2011

(54) MULTI-SIM TERMINAL HAVING A PLURALITY OF TRANSMISSION KEYS AND METHOD OF OPERATING THE SAME

(75) Inventors: Jun Sang PARK, Gyeonggi-do (KR); Seog Guen KIM, Seoul (KR); Sang Min HYUN, Seoul (KR); In Ho BAEK, Gyeonggi-do (KR)

(73) Assignee: Samsung Electronics Co., LTD., Gyeonggi-Do (KR)

(21) Appl. No.: 12/776,633

(22) Filed: May 10, 2010

(30) Foreign Application Priority Data
Nov. 4, 2009 (KR) 10-2009-0106153

(51) Int. Cl. H04W 88/02; H04W 12/06

(52) U.S. Cl. 455/411; 455/558

(57) ABSTRACT

A multi-SIM terminal having a plurality of transmission keys and a method of operating the same in which the multi-SIM terminal has at least two subscriber identification modules (SIMS) and permits a selection of any particular SIM in the same action in which a communication is requested. The terminal multi-SIM includes at least two mounting units for mounting the at least two SIMS; and at least one transmission key having at least two states corresponding one-to-one to the at least two SIMS for transmission using one of the at least two SIMS.

### CLAIM OF PRIORITY

This application claims the benefit of priority from Korean Patent Application No. 10-2009-0106153 filed in the Korean Intellectual Property Office on Nov. 4, 2009, the entire contents of which are incorporated herein by reference.

### BACKGROUND OF THE INVENTION

1. Field of the Invention

The present invention relates to a multi-SIM terminal. More particularly, the present invention relates to selecting a particular SIM in a multi-SIM terminal in which the terminal has a plurality of transmission keys and a method of operating the same.

2. Description of the Related Art

As the use of mobile terminals has become widespread, the continued development of mobile communication technology has integrated in the mobile terminal various functions of devices which were once discrete. For example, functions such as an MP3 function, mobile broadcasting reception function, moving picture reproduction function, and photographing function are commonly included in recently manufactured mobile terminals. In particular, some mobile terminals now include more than one Subscriber Identification Module (SIM). Such a terminal is referred to as a “multi-SIM terminal” that can mount two or more subscriber identification modules at the same time, for example an subscriber identification module for code division multiple access (CDMA) and an subscriber identification module for Global System for Mobile Communication (GSM). When transmitting a call or a message, a conventional multi-SIM terminal performs a selection process of selecting use of one of a plurality of mounted subscriber identification modules that can inconvenience a user who is typically interested in the substance of the communication more than how a message is communicated. Alternatively, in a default setting scenario, one of a plurality of subscriber identification modules is set as a master, and a call or a message is transmitted using the subscriber identification module set as a master.

Accordingly, in a conventional multi-SIM terminal, when transmitting a call or a message, the user either experiences inconvenience by having to select a subscriber identification module to use each time, or utilizes only a subscriber identification module set as a master.

Further, in a conventional multi-SIM terminal, during occurrence of a transmission and reception event, such as transmission and reception of a communication request or transmission and reception of a character message, the user cannot intuitively determine a subscriber identification module related to the transmission and reception event.

### SUMMARY OF THE INVENTION

The present invention provides a multi-SIM terminal having a plurality of transmission keys for enabling a user to perform a transmission event by easily selecting a desired subscriber identification module, and a method of operating the same.

The present invention further provides a multi-SIM terminal having a plurality of transmission keys and a method of operating the same in which a user can intuitively determine a subscriber identification module related to a transmission and reception event when the transmission and reception event occurs.

In accordance with an exemplary aspect of the present invention, a multi-SIM terminal having at least two subscriber identification modules (SIMS) includes: at least two mounting units for mounting the at least two SIMS; and at least one transmission key that permits at least two states that respectively correspond one-to-one to the at least two SIMS.

In accordance with another exemplary aspect of the present invention, a method of operating a multi-SIM terminal including at least two SIMS, at least one transmission key that permits at least two states that respectively correspond one-to-one to the at least two SIMS, and at least two light emitting units includes: generating a transmission event for activating one of at least two transmission keys; and performing the transmission event using user authentication information of the SIM corresponding to the activated transmission key.

### BRIEF DESCRIPTION OF THE DRAWINGS

The objects, features and advantages of the present invention will become more apparent from the following detailed description in conjunction with the accompanying drawings, in which:

FIG. 1 is a view illustrating an external appearance of a multi-SIM terminal according to an exemplary embodiment of the present invention;

FIG. 2 is a block diagram illustrating a configuration of the multi-SIM terminal according to an exemplary embodiment of the present invention; and

FIG. 3 is a flowchart illustrating a method of operating a multi-SIM terminal according to another exemplary embodiment of the present invention.

### DETAILED DESCRIPTION

Hereinafter, exemplary embodiments of the present invention are described in detail with reference to the accompanying drawings. The same reference numbers are used throughout the drawings to refer to the same or like parts. Detailed descriptions of well-known functions and structures incorporated herein may be omitted to avoid obscuring appreciation of the subject matter of the present invention by a person of ordinary skill in the art.

The views in the drawings are schematic views only, and are not intended to be to scale or correctly proportioned. While the present invention may be embodied in many different forms, specific exemplary embodiments of the present invention are shown in drawings and are described herein in detail, with the understanding that the present disclosure is to be considered as an exemplification of the principles of the invention and is not intended to limit the invention to the specific exemplary embodiments illustrated herein.

In the following description, a “subscriber identification module (SIM)” is an element for storing user authentication information necessary for using a specific wireless communication network. The term SIM includes all of a subscriber identification module, universal subscriber identification module (USIM), and a user identification module (UIM).

For convenience of description, a multi-SIM terminal in which a plurality of SIMS shares one RF unit, one storage unit, and one controller is exemplified. However, the present invention is not limited thereto. For example, a multi-SIM terminal according to another exemplary embodiment of the present invention includes a plurality of RF units, a plurality of storage units, and a plurality of controllers.

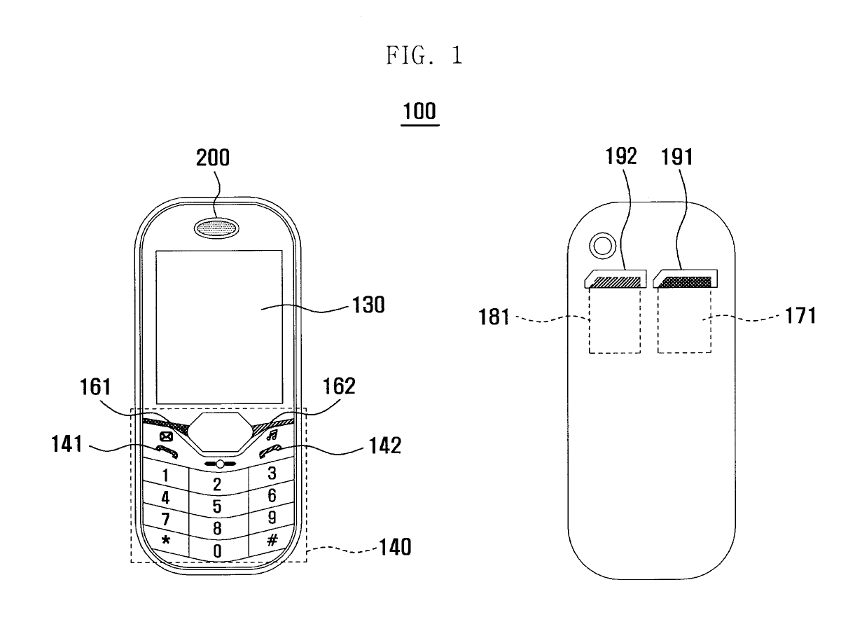

FIG. 1 is a view illustrating an external appearance of a multi-SIM terminal 100 according to an exemplary embodiment of the present invention.

As the multi-SIM terminal 100 according to the present exemplary embodiment, a bar type terminal in which a display unit 130 is positioned at an upper part of a face, and an input unit 140 is positioned at a lower part. Further, the multi-SIM terminal 100 includes two SIMS, i.e. a first SIM (SIM1) 171 and a second SIM (SIM2) 181.

Referring again to FIG. 1, the multi-SIM terminal 100 preferably includes a first transmission key 141 and a first light emitting unit 161 interlocked with the first SIM (SIM1) 171, and a second transmission key 142 and a second light emitting unit 162 interlocked with the second SIM (SIM2) 181. Further, a rear surface (a rear surface of the display unit 130) of the multi-SIM terminal 100 has a first window 191 and a second window 192 for visually inspecting at least a portion of the first SIM (SIM1) 171 and the second SIM (SIM2) 181.

The first transmission key 141 interlocks with the first SIM (SIM1) 171, and the second transmission key 142 interlocks with the second SIM (SIM2) 181. The first transmission key 141 and the second transmission key 142 are communication keys for performing a transmission event including audio dedicated communication, audiovisual communication, a character message, and a data transmission request. While two transmission keys are shown, it is within the spirit and scope of the claimed invention that a single key that, for example, toggles between the two SIMs could be used. The single key could emit a certain color when a first SIM is associated therewith, and change to a different color when a second SIM is associated therewith, as one possible example.

When the first transmission key 141 is activated, the multi-SIM terminal 100 performs a transmission event using the first SIM (SIM1) 171. For example, when inputting a phone number of another party's mobile terminal and inputting the first transmission key 141, the multi-SIM terminal 100 transmits a communication request to the base station using user authentication information (for example, a phone number) of the first SIM (SIM1) 171. Alternatively, when the second transmission key 142 is input, the multi-SIM terminal 100 transmits a communication request to a base station using user authentication information of the second SIM (SIM2) 181 and a phone number of another party's mobile terminal. Thus, the user has the option to conveniently use a particular SIM just by pressing the “send” key to initiate a call. Furthermore, the transmission keys include receive functions for receiving a communication via a particular SIM. For example, when the communication requests associated with the first SIM (SIM1) 171 and the second SIM (SIM2) 181 are simultaneously received, the user may selectively connect the communication channel via the first transmission key 141 or the second transmission key 142.

The first light emitting unit 161 interlocks with the first SIM (SIM1) 171, and the second light emitting unit 162 interlocks with the second SIM (SIM2) 181. As shown in FIG. 1, the first light emitting unit 161 and the second light emitting unit 162 are positioned between the input unit 140 and the display unit 130.

When the multi-SIM terminal 100 performs a transmission and reception event related to the first SIM (SIM1) 171 by the control of the controller 110, the first light emitting unit 161 is activated. Conversely, when the multi-SIM terminal 100 performs a transmission and reception event related to the second SIM (SIM2) 181, the second light emitting unit 162 is activated. The first light emitting unit 161 and the second light emitting unit 162 preferably emit light having different colors.

With continued reference to FIG. 1, the first window 191 and the second window 192 are formed at a position corresponding to the first SIM (SIM1) 171 and the second SIM (SIM2) 181. In other words, a user can easily determine whether the first SIM (SIM1) 171 and the second SIM (SIM2) 181 are mounted through the windows 191 and 192. Further, the user can determine a color of a first mounting unit (not shown) in which the first SIM (SIM1) 171 is mounted and a color of a second mounting unit (not shown) in which the second SIM (SIM2) 181 is mounted through the windows 191 and 192. The windows 191 and 192 may be formed in one window.

As the multi-SIM terminal 100 separately has transmission keys interlocked with a plurality of SIMS, respectively, when requesting transmission of a call or a message, a process of selecting a SIM can be omitted, unlike a conventional case, thereby providing user convenience.

Further, when a transmission and reception event related to the first SIM (SIM1) 171 occurs, the multi-SIM terminal 100 activates the first light emitting unit 161, and when a transmission and reception event related to the second SIM (SIM2) 181 occurs, the multi-SIM terminal 100 activates the second light emitting unit 162. Thereby, the user can intuitively determine a SIM related to a presently occurring transmission and reception event.

Further, preferably the multi-SIM terminal 100 matches a color of a first mounting unit (not shown) in which the first SIM (SIM1) 171 is mounted, a color of the first transmission key 141, and a light emitting color of the first light emitting unit 161, and matches a color of a second mounting unit (not shown) in which the second SIM (SIM2) 181 is mounted, a color of the second transmission key 142, and a light emitting color of the second light emitting unit 162, thereby providing user convenience. For example, when the user does not know a state of a SIM mounted in the multi-SIM terminal 100, the user can determine a mounting state of a SIM through the window and easily determine the corresponding transmission key through a color of a mounting unit in which the SIM is mounted.

A mounting position of the first light emitting unit 161 and the second light emitting unit 162 is not limited to a position shown in FIG. 1. For example, the first light emitting unit 161 and the second light emitting unit 162 may be positioned at various positions of the multi-SIM terminal 100, for example at both sides of a speaker 200. In addition, the multi-SIM terminal 100 according to the present exemplary embodiment is not limited to a bar type terminal. That is, the multi-SIM terminal 100 according to the present exemplary embodiment may be formed in various types, including but in no way limited to types such as a folder type and a slide type terminal.

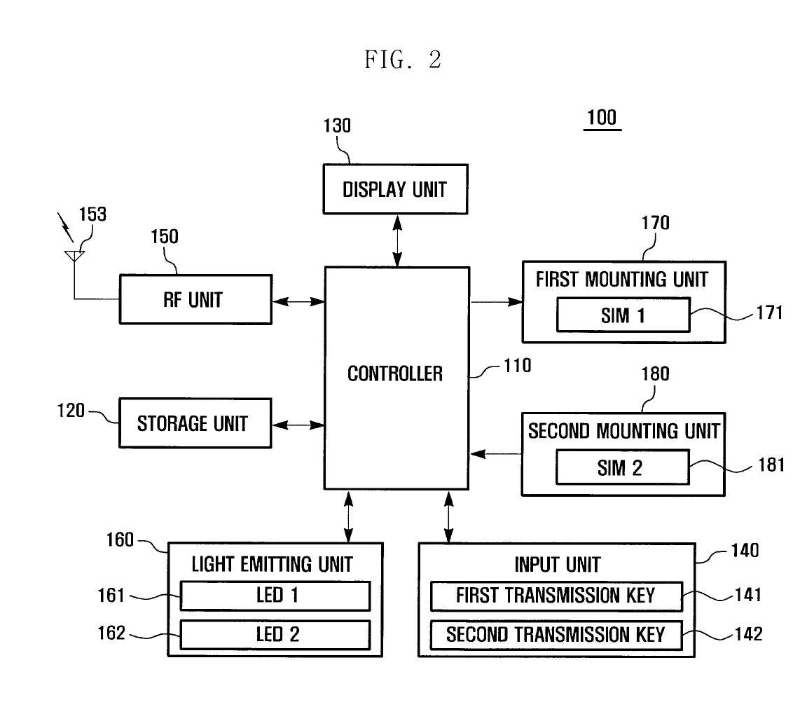

Each element of the multi-SIM terminal 100 is now described in detail with reference to FIG. 2.

FIG. 2 is a block diagram illustrating a configuration of the multi-SIM terminal 100 according to an exemplary embodiment of the present invention.

Referring to FIG. 2, the multi-SIM terminal 100 preferably includes a controller 110, storage unit 120, display unit 130, input unit 140, RF unit 150, light emitting unit 160, first mounting unit 170, and second mounting unit 180. The first SIM (SIM1) 171 is mounted in the first mounting unit 170, and the second SIM (SIM2) 181 is mounted in the second mounting unit 180. The light emitting unit 160 includes the first light emitting unit 161 and the second light emitting unit 162, and the input unit 140 includes the first transmission key 141 and the second transmission key 142.

The first SIM (SIM1) 171 is inserted into the first mounting unit 170, and the first mounting unit 170 performs a function of an interface unit for connecting the first SIM (SIM1) 171 and the controller 110. The first SIM (SIM1) 171 stores user authentication information (for example, IMSI and a phone number) necessary for using a wireless communication network.

The second SIM (SIM2) 181 is inserted into the second mounting unit 180 and performs a function of an interface unit for connecting the second SIM (SIM2) 181 and the controller 110. Similar to the first SIM 171. the second SIM (SIM2) 181 stores user authentication information necessary for using a wireless communication network.

The RF unit 150 transmits and receives a wireless signal to and from a wireless communication network for providing a communication service using a specific wireless communication method (for example, CDMA, GSM, General packet radio service (GPRS), and wideband code division multiple access (WCDMA)). For this, the RF unit 150 includes a transmitter (not shown) for modulating a signal output from the controller 110, up-converting a frequency of a signal to be transmitted, and transmitting the signal through an antenna 153, and a receiver (not shown) for down-converting a frequency of a signal received through the antenna, demodulating the signal, and outputting the signal to the controller 110. For example, when the first transmission key 141 or the second transmission key 142 is input, the RF unit 150 transmits and receives an audio dedicated communication request, audiovisual communication request, and character message to and from the corresponding wireless communication network under the control of the controller 110.

While FIG. 2 shows an RF unit 150, however the present invention is not limited thereto. For example, when the SIM uses different wireless communication methods, the RF unit 150 may be formed with a plurality of RF units.

The display unit 130 displays user data input by a user, function setting information, or various information provided to the user as well as various menu screens of the multi-SIM terminal 100. For example, the display unit 130 displays, for example, a booting screen, a standby screen, a menu screen, and an audiovisual communication screen. The display unit 130 is formed with a liquid crystal display (LCD) and an organic light-emitting diode (OLED). However, any type of thin film technology can be used for the display unit. When the display unit 130 is formed with a touch screen, the display unit 130 can be operated as an input means which can supplement or replace, for example, alpha-numeric keys of a keypad.

The input unit 140 is used for inputting numerals or various character information, and includes input keys and function keys for setting various functions and controlling a function of the mobile terminal 100. For example, the input unit 140 includes an MP3 key for reproducing music, a volume key for adjusting an output volume of an audio signal, and a navigation key having at least four directions. Particularly, in the present exemplary embodiment, the input unit 140 includes the first transmission key 141 for performing a transmission request related to the first SIM (SIM1) 171 and the second transmission key 142 for performing a transmission request related to the second SIM (SIM2) 181. That is, as the multi-SIM terminal 100 according to the present exemplary embodiment has a separate transmission key corresponding one-to-one to a plurality of SIMS, a process of selecting a SIM for performing a transmission event can be omitted, unlike a conventional case, thereby providing user convenience.

The light emitting unit 160 is an element for emitting light when power is supplied and is mounted to be exposed to the outside so that a user can intuitively determine an operating state of the multi-SIM terminal 100, for example a state of a SIM related to a transmission and reception event among a plurality of SIMS. The light emitting unit 160 is formed with a light-emitting diode (hereinafter, an LED). Particularly, in the present exemplary embodiment, the light emitting unit 160 includes the first light emitting unit 161 interlocked with the first SIM (SIM1) 171 and the second light emitting unit 162 interlocked with the second SIM (SIM2) 181.

When a transmission and reception event related to the first SIM (SIM1) 171 occurs, the first light emitting unit 161 is activated and emits light, and when a transmission and reception event related to the second SIM (SIM2) 181 occurs, the second light emitting unit 162 is activated and emits light. In this case, the first light emitting unit 161 and the second light emitting unit 162 emit light with different colors. Further, the first light emitting unit 161 and the second light emitting unit 162 are turned on or off according to a predetermined cycle for a predetermined time period by the control of the controller 110. Thereby, the user intuitively determines a SIM related to a transmission and reception event. The transmission event includes a communication request, character message transmission and reception request, and data transmission and reception request. It is also possible that “SIM1” or “SIM2” can display on the display, or some other type of easily recognizable icon. Moreover, the protocol such as “CDMA” or “GSM” can be displayed instead of or in addition to the light.

The storage unit 120 stores general operations of the multi-SIM terminal 100, a program necessary for performing communication with a wireless communication network, and data generated while performing the program. The storage unit 120 stores an operating system for booting the multi-SIM terminal 100, an application program necessary for operating a function of the multi-SIM terminal 100, and data generated when using the multi-SIM terminal 100. Particularly, in the present exemplary embodiment, the storage unit 120 stores an application program for controlling the light emitting unit 160 to activate the first light emitting unit 161 when a transmission and reception event (a request for communication and a request for transmission and reception of a character or data) related to the first SIM (SIM1) 171 occurs and for controlling the light emitting unit 160 to activate the second light emitting unit 162 when a transmission and reception event related to the second SIM (SIM2) 181 occurs.

In FIG. 2, the multi-SIM terminal 100 according to the present exemplary embodiment includes what appears as a single storage unit 120, however the present invention is not limited thereto. That is, when the multi-SIM terminal 100 uses a plurality of different wireless communication methods, the multi-SIM terminal 100 includes a plurality of storage units for storing programs for controlling wireless communication methods, respectively.

The controller 110 controls general operations of the multi-SIM terminal 100 and a signal flow between elements of the multi-SIM terminal 100. Particularly, in the present exemplary embodiment, when a transmission event (for example, a communication request and transmission of a character message) occurs using one of the first transmission key 141 and the second transmission key 142, the controller 110 performs a transmission event using the corresponding SIM. For example, the controller 110 controls the RF unit 150 to transmit a communication request using the user authentication information of the first SIM (SIM1) 171 by inputting a phone number of another party's mobile terminal and the first transmission key 141 for a user to request communication. Alternatively, the controller 110 controls the RF unit 150 to transmit the communication request using the second SIM (SIM2) 181 by inputting a phone number of another party's mobile terminal and the second transmission key 142 for a user to request communication.

Further, the controller 110 controls operation of the light emitting unit 160 to correspond to occurrence of a transmission and reception event so that the user can intuitively determine an operating state of the multi-SIM terminal 100 through the first light emitting unit 161 and the second light emitting unit 162, which are exposed to the exterior environment of the terminal. For example, the controller 110 controls activation of the first light emitting unit 161 when a transmission and reception event related to the first SIM (SIM1) 171 occurs and also controls activation of the second light emitting unit 162 when a transmission and reception event related to the second SIM (SIM2) 181 occurs. In this case, the controller 110 controls turning on or off the light emitting unit 160 to correspond to a transmission and reception event according to a predetermined cycle for a predetermined time period.

Although not shown, the multi-SIM terminal 100 may further include elements having an additional function, such as a camera module for photographing an image or a moving picture, a short range communication module for performing short range wireless communication, a broadcasting reception module for receiving broadcasting, and a digital sound source reproduction module such as an MP3 module, a GPS module, etc.

A method of operating the multi-SIM terminal 100 having a plurality of transmission keys according to an exemplary embodiment of the present invention will now be described in detail hereinafter.

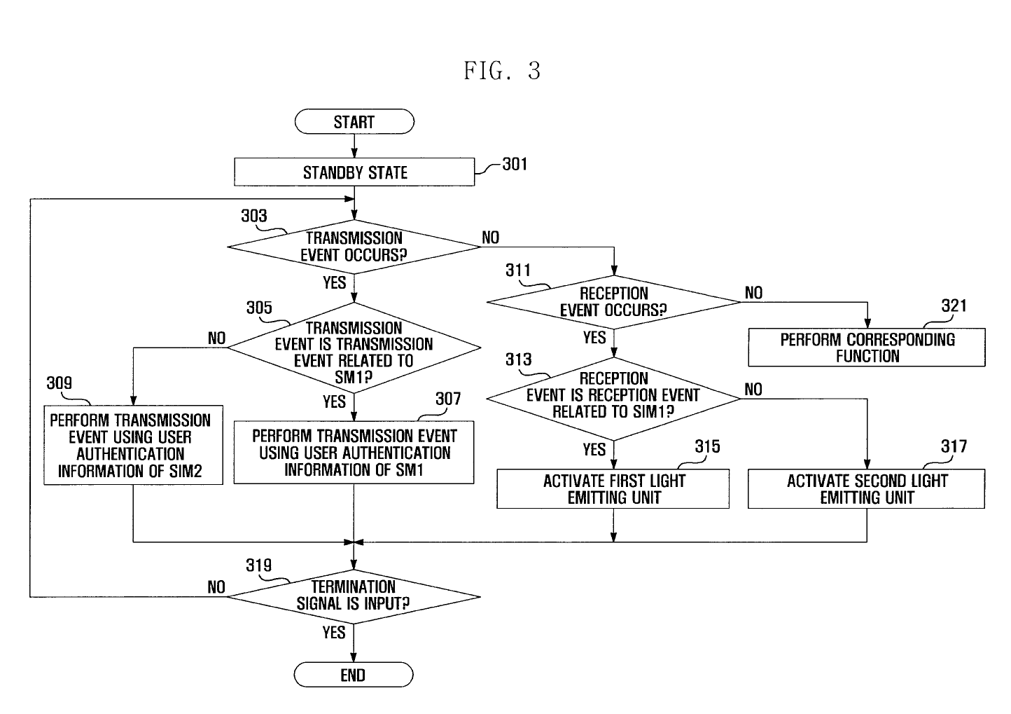

FIG. 3 is a flowchart illustrating a method of operating the multi-SIM terminal 100 having a plurality of transmission keys according to another exemplary embodiment of the present invention.

Referring now to FIGS. 2 and 3, at step (301), after a booting process is terminated, the controller 110 is in a standby state.

At step (303), the controller 110 determines whether or not a transmission event occurs (303). Here, the transmission event preferably includes audio dedicated communication, audiovisual communication, character message transmission, and wireless Internet connection request. If a transmission event occurs, then at step (305) the controller 110 determines whether a transmission event is a transmission event related to the first SIM (SIM1) 171. That is, the controller 110 determines whether or not the first transmission key 141 is input. If a transmission event is a transmission event related to the first SIM (SIM1) 171, i.e. if the first transmission key 141 is input, then at step (307) the controller 110 performs a transmission event using user authentication information (for example, international mobile subscriber identity (IMSI) or a phone number) of the first SIM (SIM1) 171. For example, when the user inputs a phone number of another party's mobile terminal and inputs the first transmission key 141, the controller 110 controls the RF unit 150 to transmit a communication request to a base station related to the first SIM (SIM1) 171. In this case, the controller 110 controls to include a phone number of the first SIM (SIM1) 171 in a sender's information and to transmit a communication request to another party's mobile terminal.

However, if at step 305, a transmission event is not a transmission event related to the first SIM (SIM1) 171, i.e. if the second transmission key 142 is activated, at step (309) the controller 110 controls performance of a transmission event using user authentication information of the second SIM (SIM2) 181. For example, when the user inputs a phone number of another party's mobile terminal and inputs the second transmission key 142, the controller 110 controls the RF unit 150 to transmit a communication request to a base station related to the second SIM (SIM2) 181. In this case, the controller 110 controls to include a phone number of the second SIM (SIM2) 181 in a sender's information and to transmit a communication request.

If a transmission event does not occur at step (303), then at step (311) the controller 110 determines whether or not a reception event occurs. Here, the reception event includes audio dedicated communication, audiovisual communication, character message reception. If a reception event does not occur, then at step (321) the controller 110 performs a corresponding function. For example, the controller 110 performs a music reproduction function according to a music reproduction request, or performs a broadcasting reproduction function according to a broadcasting reproduction request. If a reception event occurs at step 311, at step (313) the controller 110 determines whether the reception event is a reception event related to the first SIM (SIM1) 171.

If at step (315) the reception event is a reception event related to the first SIM (SIM1) 171, the controller 110 controls activation of the first light emitting unit 161. In this case, the controller 110 controls turning on or off the first light emitting unit 161 according to a predetermined cycle for a predetermined time period. The first light emitting unit 161 emits light with a predetermined first color.

If the reception event is not a reception event related to the first SIM SIM1 171, i.e. if the reception event is a reception event related to the second SIM SIM2, 181, then at step (317) the controller 110 controls to activate the second light emitting unit 162. In this case, the controller 110 controls to turn on or off the second light emitting unit 162 according to a predetermined cycle for a predetermined time period. The second light emitting unit 162 emits light with the second color different from the first color.

At step (319), the controller 110 determines whether a termination signal is input. If a termination signal is input, the controller 110 turns off power. If a termination signal is not input, the process then returns to step 303.

Although not shown in FIG. 3, when a transmission event occurs, the controller 110 preferably activates a light emitting unit interlocked with a SIM corresponding to occurrence of the transmission event.

For example, when a transmission event related to the first SIM (SIM1) 171 occurs, the controller 110 turns on or off the first light emitting unit 161 with a first color according to a predetermined cycle for a predetermined time period. Further, when a transmission event related to the second SIM (SIM2) 181 occurs, the controller 110 turns on or off the second light emitting unit 162 with a second color according to a predetermined cycle for a predetermined time period.

Further, while the multi-SIM terminal 100 includes a controller, a storage unit, and an RF unit is exemplified, however the present invention is not limited thereto. That is, when the multi-SIM terminal 100 according to the present exemplary embodiment uses a plurality of different wireless communication networks, the multi-SIM terminal 100 includes a plurality of controllers, a plurality of storage units, and a plurality of RF units corresponding to the plurality of wireless communication networks. Moreover, additional items may be integrated into a single unit or a reduced number of units from what is shown and described.

Further, in the foregoing description, the multi-SIM terminal 100 includes two SIMS 171 and 181, and two light emitting units 161 and 162, two transmission keys 141 and 142, and two windows 191 and 192 corresponding to the two SIMS 171 and 181, respectively, being exemplified. However, the present invention is not limited thereto. For example, when the multi-SIM terminal 100 according to an exemplary embodiment of the present invention may include three or more SIMS, the multi-SIM terminal 100 may include three or more transmission keys, three or more light emitting units, and three or more windows corresponding to the three or more SIMS.

As described above, in a multi-SIM terminal having a plurality of transmission keys and a method of operating the same according to the present invention, by providing separate transmission keys corresponding to a plurality of SIMS, a user can easily perform a transmission event using a desired SIM without a process of selecting a SIM, thereby providing user convenience. Further, a SIM interlocked with a transmission and reception event can be intuitively determined by the user.

The above-described methods according to the present invention can be realized in hardware or as software or computer code that can be stored in a recording medium such as a thumbnail drive, CD ROM, a RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail hereinabove, it should be clearly understood that many variations and modifications of the basic inventive concepts herein described, which may appear to those skilled in the art, will still fall within the spirit and scope of the exemplary embodiments of the present invention as defined in the appended claims. For example, while preferable a respective transmission key for each SIM, it is possible to use a single key for two SIMS, whereby the single key is pressed together with, for example, a shift key for SIM 1 and without the shift key for SIM 2. Thus a device with four SIMS could be operated two transmission keys and a shift key, for example.

What is claimed is:

1. A multi-SIM terminal having at least two subscriber identification modules (SIMS), comprising:
at least two mounting units for mounting the at least two SIMS; and
at least one transmission key having at least two states corresponding one-to-one to the at least two SIMS for transmission using one of the at least two SIMS.

2. The multi-SIM terminal of claim 1, wherein the transmission key comprises at least two transmission keys corresponding one-to-one to the at least two SIMS.

3. The multi-SIM terminal of claim 2, further comprising at least two light emitting units corresponding one-to-one to the at least two SIMS.

4. The multi-SIM terminal of claim 3, further comprising a controller for performing a transmission event using SIM information corresponding to the activated one transmission key, if a transmission event activating one of the at least two transmission keys occurs.

5. The multi-SIM terminal of claim 4, wherein the transmission event comprises at least one of transmission of a communication request, a transmission of a character message, and a transmission of data.

6. The multi-SIM terminal of claim 2, wherein the transmission keys activate send functions for initiating a communication with a particular SIM.

7. The multi-SIM terminal of claim 2, wherein the transmission keys include receive functions for receiving a communication via a particular SIM.

8. The multi-SIM terminal of claim 3, wherein the at least two light emitting units emit light with different colors.

9. The multi-SIM terminal of claim 4, wherein the controller controls to activate a light emitting unit corresponding to a transmission and reception event when the transmission and reception event occurs.

10. The multi-SIM terminal of claim 4, wherein the controller controls the at least two light emitting units to emit light with different intensities or visibly distinguishable duty cycles.

11. The multi-SIM terminal of claim 4, wherein the controller turns on or off a light emitting unit corresponding to the transmission and reception event according to a predetermined cycle for a predetermined time period.

12. The multi-SIM terminal of claim 1, further comprising a window for visually distinguishing at least a portion of the at least two mounting units for mounting the at least two SIMS.

13. A method of operating a multiple subscriber identification modules (multi-SIM) terminal comprising at least two SIMS, at least one transmission key having at least two states to respectively correspond one-to-one to the at least two SIMS, and at least two light emitting units, comprising:
generating a transmission event for activating one of at least two transmission keys; and
performing the transmission event using user authentication information of the SIM corresponding to the activated transmission key.

14. The method of claim 13, wherein each of said at least two SIMS includes a respective transmission key.

15. The method of claim 14, further comprising activating the light emitting unit related to the SIM corresponding to the activated transmission key.

16. The method of claim 15, wherein activating the light emitting unit related to the SIM corresponding to the activated transmission key comprises turning on or off the light emitting unit according to a predetermined cycle for a predetermined time period.

17. The method of claim 15, wherein activating the light emitting unit related to the SIM corresponding to the activated transmission key comprises emitting the light emitting unit related to the SIM corresponding to the activated transmission key with preset color.

18. The method of claim 14, further comprising:
generating a reception event related to one of the at least two SIMS; and
activating the light emitting unit corresponding to said one of the at least two SIMS.

19. The method of claim 18, wherein activating the light emitting unit corresponding to said one of the at least two SIMS comprises turning on or off the light emitting unit according to a predetermined cycle for a predetermined time period.

20. The method of claim 18, wherein activating the light emitting unit corresponding to said one of the at least two SIMS comprises emitting the light emitting unit corresponding to said one of the at least two SIMS with preset color.
